(19) United States
(12) Patent Application Publication
(10) Pub. No.: US 2006/0260452 A1
(43) Pub. Date: Nov. 23, 2006

(54) Container for fabric roll

(76) Inventors: Fu-Lai Yu, Taipei Hsieh (TW); Chin-Tien Huang, Taipei Hsieh (TW); Shun-Chi Yu, Taipei Hsieh (TW)

Correspondence Address: OLSON & HIERL, LTD., 20 NORTH WACKER DRIVE, 36TH FLOOR, CHICAGO, IL, 60606, US

(21) Appl. No.: 11/135,858

(22) Filed: May 23, 2005

(51) Int. Cl. B26D 1/18

(52) U.S. Cl. 83/56; 83/649; 83/614

(57) ABSTRACT

A system for customizing lengths of fabric material for constructing rows of a window covering. The system includes a container box supported by a substrate and a cutter for trimming desired lengths of material from a roll of material.

### TECHNICAL FIELD OF THE INVENTION

This invention relates to a system for customizing fabric panels for use in the construction of rows of a window covering.

### BACKGROUND OF THE INVENTION

Decorative window coverings are popular items for providing privacy and blocking light. These window coverings take on various forms, such as Roman shades, Venetian blinds, vertical blinds, honeycomb shades, and the like. Typically, window coverings include a panel or plurality of rows that cover an opening, which are connected to an adjustment mechanism in a headrail with one or more control members, such as cords.

One type of window covering is discussed in co-pending application Ser. No. 10/427,829, which is hereby incorporated by reference. Disclosed therein in a unique window covering comprising a plurality of rows of panels. Each of the panels may be opened by narrowing the width of the profile of the panel to create gaps between the individual rows. Another type of window covering is disclosed in co-pending application Ser. No. 10/930,021, which is hereby incorporated by reference. In this disclosure, a novel Venetian type blind that is constructed of a plurality of panels is discussed.

With any of the aforementioned window coverings, a problem that exists is a result of the fact that window spaces come in many different widths. Because of this, it is typical that window coverings need to be custom ordered to fit a particular window space. For example, with conventional Venetian blinds, the head rail, bottom rail and blind slats would need to be cut to particular widths, and then assembled by the manufacturer. With either of the window coverings discussed above, the fabric material from which the panels are constructed must be customized to a desired length. These custom processes require a substantial amount of time for each particular window because an order must be placed with a retailer. The retailer then sends the customer order to the manufacturer for assembly of the blind. Several days or even weeks may pass between when the customer chooses the window coverings and when the finished window covering is finally received.

One method for overcoming this problem is discussed in co-pending application Ser. No. 10/984,066, which is incorporated herein by reference. The panel disclosed may be readily cut to the desired width and constructed into a suitable panel. The present invention provides a system and method for customizing such fabric material or other rolls of fabric material, and enables a user to easily customize desired lengths of fabric material for constructing panels of a window covering at a point of sale. The system also enables a user to stack and store supplies of fabric for customization. Other advantages of the system of the present invention will be readily apparent to those of ordinary skill in the art.

### SUMMARY OF THE INVENTION

The present invention relates to a system and method for customizing fabric panel lengths for window coverings. The system includes a fabric roll container box, a substrate for supporting the container box, a cutter, and a measurement device. The fabric roll container box includes a shell, such as a cube-like box, which is preferably made of a rigid material, such as paperboard, plastic, or the like. The shell also defines a base, a pair of opposed walls, and a front panel. A spindle that is adapted for supporting a roll of material within the shell is also included. Fabric material is wound into a roll on the spindle, and the spindle with the roll of fabric thereon is installed within the shell such that it is supported between the pair of opposed walls.

A rotary key is provided to support one end of the spindle. The rotary key penetrates at least one of the opposed walls, and preferably protrudes through the wall. Preferably, the rotary key also includes a handle for user manipulation. The other end of the spindle may be supported by a hub or the like, which is engaged with the wall opposing the rotary key. The rotary key is adapted to rotate the spindle and roll of fabric thereon to control the winding and unwinding of the fabric material. For example a spindle with a roll of fabric wound thereon is rotated in one direction by turning the rotary key to unwind a length of material. By turning the rotary key in the opposite direction, the fabric is wound onto the spindle. As an alternative, the hub may be a second rotary key which enables control of the fabric roll from either side of the container box. An additional feature is a latch for the rotary key. The latch prevents undesired rotation of the spindle, such as when the container box is being moved to or from storage, which may result in material unwinding from the roll.

The front panel of the shell is preferably in a hinged relationship with the shell, such that it may be fully opened to enable replacement fabric rolls to be installed. By opening the front panel, a user is also able to pull lengths of material from the roll for customization. However, it is preferred that the front panel is configured such that when the front panel is closed, a slot is formed in the shell to allow fabric unwound from the spindle to be guided out of the container box. A flap panel may also be included that overlaps the slot when closed.

Another preferred feature of the container box is a window integral with at least one of the pair of opposed walls. The window is adapted to enable a person to view the amount of fabric material on the roll in order to determine whether a replacement roll of fabric will be needed in the near future. The window may also include markings that provide guidance as to the amount of fabric material remaining on the roll so that additional rolls of material can be ordered ahead of time.

In order to customize a length of material for a panel, the flap panel is opened to expose the slot in the front panel. A user rotates the rotary key to unwind the fabric from the roll within the container box. Material is either pulled from the container box, or the rotary key is turned further. The desired length of material is measured and the desired length cut. Additional lengths of material are similarly cut as needed. In a preferred embodiment of the system, a cutter is secured with the substrate, such as a table, to facilitate cutting and maintain proper alignment of the fabric material to ensure a perpendicular cut. The cutter, such as a rotating blade or straight blade, is mounted to a sliding support movable relative to an elongated rod. The elongated rod passes transversely across the fabric material to be cut. The sliding support is moved along the rod to cut the fabric. In order to obtain a clean cut of certain fabric, it is preferred that a heating device, cooling device, or ultrasonic device is provided to heat or cool the device before cutting. When the desired length of fabric has been cut, any unwound fabric can be rewound on the roll by turning the rotary key in an opposite direction. When the customization of lengths of material is completed, the flap panel is closed to minimize dirt or dust from getting on the fabric within the container box. Other cutters are also appropriate, such as shears or scissors.

It is preferred that the base includes a securement member for securing the container box to the substrate. This is because as the fabric roll is consumed, the weight of the container box decreases such that the box may become unstable as material is wound and unwound. Securing the container box to the substrate enables greater ease in correctly unwinding the fabric roll and cutting desired lengths of material by maintaining the position and alignment of the container box on the substrate. For example, the container box may include securement members, such as positioning slots, on a bottom surface of the base. The positioning slots can engage with positioning projections provided on the working surface of the substrate, such as pegs, when the bottom surface of the container box rests thereon. The position of the container box is thereby secured when fabric is the unwound and wound in order to achieve better control over the customization of the panels. The securement of the container box to the substrate also enables material to be pulled from the roll more easily.

Another advantage of the container box is that it can protect and prevent undesirable damage and soiling of the fabric roll. Further, the container box allows convenient stacking of fabric roll supplies. The container box also provides a way of displaying the various fabric options for a customer. For example, the front panel may be formed of a transparent material through which a customer can view his or her choices from a stacked display.

The system of the present invention can be provided to users in different combinations. In one embodiment, the fabric roll can be sold to a retailer or a fabricator in the form of a package with the container box. The substrate utilized can be any suitable table or countertop, the cutter may be scissors or shears, and the measurement device can be a tape measure or the like. When the fabric roll is completely consumed, the user can dispose of the container box or reuse it by installing replacement fabric rolls, which are sold without the container box. Alternatively, an entire system can be provided wherein a cutter and measurement device are integral with the substrate, such as a table.

### BRIEF DESCRIPTION OF THE DRAWINGS

In the drawings,

FIG. 1 is a perspective view of a preferred embodiment of a system for customizing lengths of material for panels of a window covering according to the present invention;

FIG. 1A is a enlarged partial view of FIG. 1 showing the cutter;

FIG. 2 is an exploded perspective view of the container box of the system of FIG. 1;

FIG. 3 is a perspective view of the container box of FIG. 1;

FIG. 4 is an exploded perspective view of the system of FIG. 1; and

FIG. 4A is a perspective bottom view of the container box of FIG. 1.

### DESCRIPTION OF THE PREFERRED EMBODIMENT OF THE INVENTION

The invention disclosed herein is susceptible of embodiment in many different forms. Shown in the drawings and described hereinbelow in detail is one preferred embodiment of the invention. It is to be understood, however, that the present disclosure is an exemplification of the principles of the invention and does not limit the invention to the illustrated embodiment.

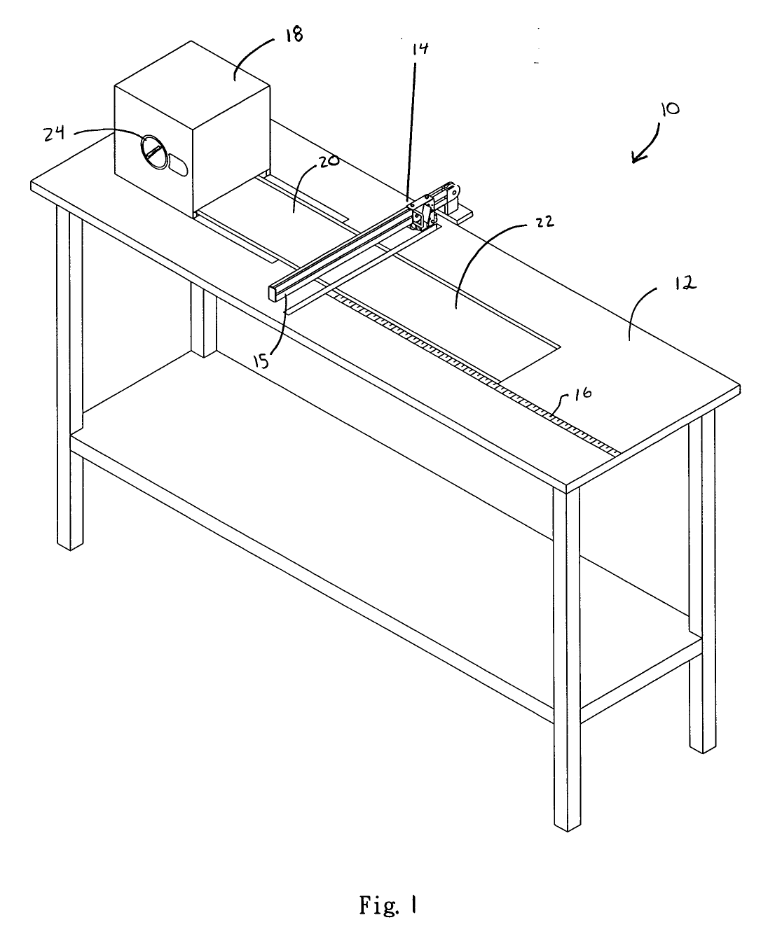

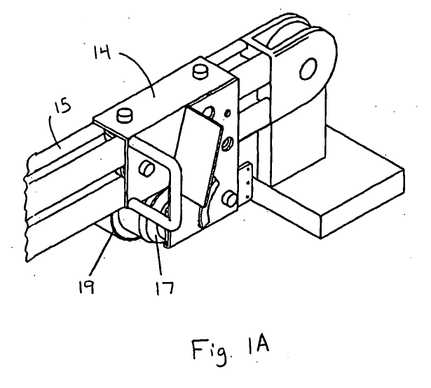

A preferred embodiment of a system for customizing fabric panels for construction of window covering is shown in FIG. 1. The system 10 includes a substrate, such as table 12, a cutter 14, a measuring device, such as ruler 16, and a container box 18. Fabric material 20 suitable for constructing panels and rows of a window covering, such as that described in co-pending application Ser. No. 10/984,066 is pulled from the container box 18 and is laid on table 12. The ruler 16, which may be integral with the table 12, is positioned with the cutter 14 such that the position of cutter 14 marks a zero point. A desired length of material 22 is pulled past cutter 14. A user then cuts the desired length of material 22 with cutter 14.

An example of a suitable cutter is shown in FIG. 1A. The cutter 14 is positioned with guide 15 so that a clean and even cut is easily made to fabric 20. Cutter 14 includes a rotating blade 17 and a heating device 19, which heats blade 17 so that a cleaner cut is achieved. Although not shown, clamps or other means for securing the fabric material 22 to the table 12 during cutting can be utilized. Additional material can be pulled from the container box 18, measured, and cut into desired lengths as needed. After cutting, any excess material is retracted into container box 18 by turning rotary key 24 on container box 18. While in the preferred embodiment of the system 10, a cutter is provided integrally with the substrate, this is not required. Instead, standard shears or scissors may be utilized. Similarly, it is preferred that the ruler 16 is integral with the substrate, however, as discussed above, this is not required.

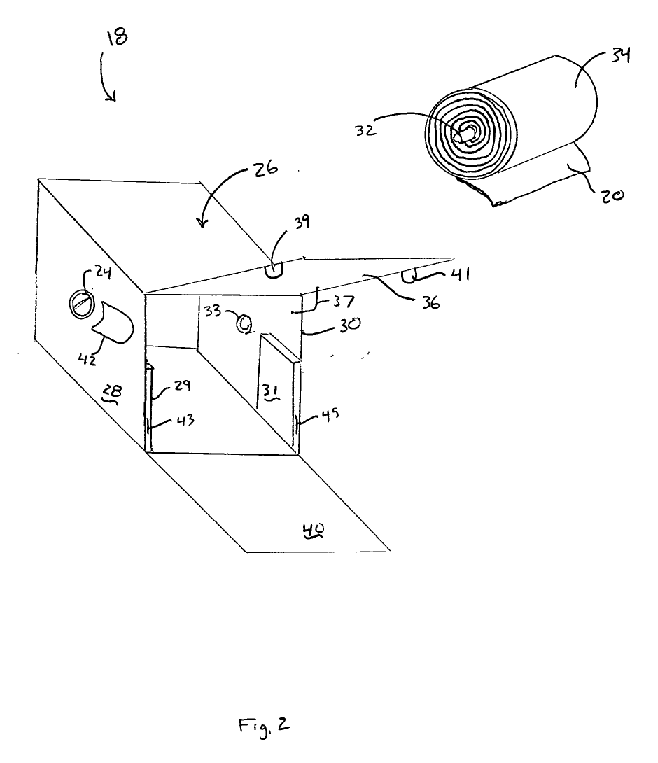

Further details of container box 18 are discussed with reference to FIG. 2. Container box 18 includes a shell 26 which defines a pair of opposed walls 28 and 30. A hub 33 is incorporated with wall 30, and rotary key 24 is formed with wall 28. A spindle 32 having a roll 34 of fabric material 20 is also provided. Spindle 32 is adapted to engage rotary key 24 and hub 33 such that the roll 34 of fabric material 20 is supported within the shell 26. As discussed above, turning the rotary key 24 causes the spindle 32 and roll 34 of fabric material 20 thereon to rotate. By turning the rotary key 24 in one direction, fabric material 20 is unwound from the roll 34. By turning the rotary key 24 in the opposite direction, the fabric material 20 is wound onto roll 34. The rotary key 24 fully penetrates wall 28, and thus may be operated from the exterior of the shell 26. Hub 33 may also be a rotary key thereby providing for control of the supply of fabric material from either side of shell 26.

Preferably formed on the interior of shell are guide members 29 and 31, which may be integral with walls 28 and 30. Guide members 29 and 31 are spaced apart slightly wider than the width of fabric material 20 such that the fabric material 20 is evenly rolled onto spindle 32 and roll 34. Guide members 29 and 31 also lessen the degree of lateral shift possible by the roll 34, and also prevent material from being caught up with the spindle 32, rotary key 24 or hub 33, which can undesireably lead to damage of the fabric material 20 or impair the freedom of rotation of the spindle 32.

A front panel 36, which is shown in a hinged relationship with the shell 26, is also provided. A brace 37 is included to enable the front panel 36 to be held in an open position so the user is able to use both hands to install roll 34 in the container box 18. Front panel 36 also includes a pair of tabs 39 and 41 which engage with slots 43 and 45 to hold front panel 36 closed.

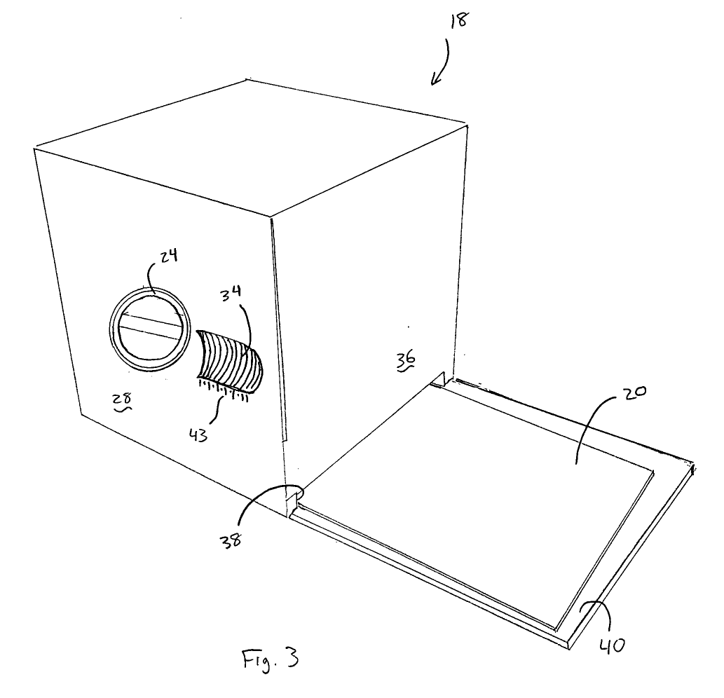

Referring to FIG. 3, when the front panel 36 is closed, a slot 38 is left open. Rotary key 24 is rotated in a direction to unwind fabric material 20 from the roll 34. The fabric material 20 from the roll 34 is pulled through slot 38, measured, and cut as discussed above. While it is preferred that slot 38 be included in front panel 36, the material may also be drawn from the container box 18 by opening cover flap 40 and front panel 35 as shown in FIG. 2.

A cover flap 40 may also be provided that is also in a hinged relationship with the shell 26. Cover flap 40 overlaps slot 38 such that container box 18 is closed when not in use. Cover flap 40 or front panel 36 may optionally be formed of a transparent material to enable a user to view the roll 34 even when the cover flap 40 and front panel 26 are closed. In such an embodiment, a user can stack his or her supply of fabric rolls in container boxes and display them to customers. A customer can simply select the desired material from the stacks, and the particular container box pulled down and placed on the table 12.

Either or both opposed walls 28 and 30 may also define a window or aperture, such as window 42 formed in wall 28. A user is able to view the roll 34 of fabric material 20 through the window 42 to determine the remaining supply of material 20. A series of markings 43 may also be placed along the window 42 to provide an indication of to the amount of material remaining on the roll 34. For example, markings 43 may indicate that approximately half of the material has been used.

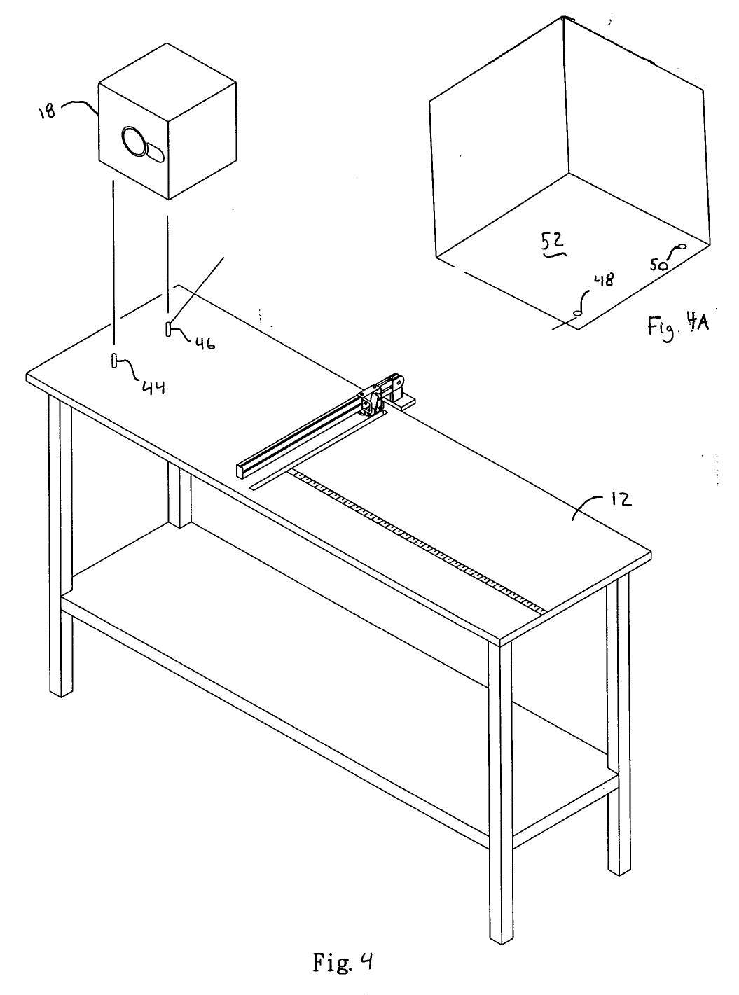

Yet another optional feature of the present invention is discussed with reference to FIGS. 4 and 4A. As fabric material is consumed and the fabric roll becomes smaller, the weight of the container box 18 lightens such that it may become unstable when customizing the desired lengths of material. In order to prevent this problem, a securement member is provided to secure the container box 18 to the substrate, such as table 12. Formed with table 12 are a pair of pegs 44 and 46, which are adapted to engage slots 48 and 50 formed with base 52 of container box 18 (FIG. 4A). Other ways of securing the container box 18 to the substrate, such as table 12 will be readily apparent to those skilled in the art, including hook and loop enclosures, latches, ties, or the like. It is also possible that the container box 18 may be integral with the substrate. In such an embodiment, the particular roll of fabric material to be customized may be installed into the container box as desired. Securement member, such as slots 48 and 50 also maintain the desired alignment for the container box 18 relative to the cutter 14 and ruler 16.

While the shape of the box is shown as being cube-shaped, other shapes are possible. It is preferred, however, that a parellelpiped container box be utilized in order to facilitate stability and stacking of boxes for storage and display purposes. It is also possible that more than one roll may be distributed from a container box. Although not shown, such an embodiment would include a plurality of rotary keys and support multiple rolls of material.

The foregoing descriptions are to be taken as illustrative, but not limiting. Still other variants within the spirit and scope of the present invention will readily present themselves to those skilled in the art.

What is claimed is:

1. A container box for a roll of fabric material, the container box comprising:
a shell defining a pair of opposed walls;
a spindle adapted for supporting a roll of fabric material within the shell;
a rotary key adapted for engagement with the spindle, wherein rotation of the rotary key causes rotation of the spindle, the rotary key penetrating at least one of the opposed walls; and
a front panel positioned between the pair of opposed walls adapted to permit material unwound from the roll to exit the shell.

2. The container box of claim 1, wherein the front panel defines a slot through which material unwound from the roll is guided.

3. The container box of claim 1, wherein at least one of the pair of opposed walls further comprises a window.

4. The container box of claim 1, wherein the front panel is in a hinged relationship with the shell such that an interior of the shell is accessible by opening the front panel.

5. The container box of claim 1, further comprising a base panel having a securement member for securement with a substrate.

6. The container box of claim 1, further comprising a guide member integral with the pair of opposed walls.

7. A fabric panel customization system, the system comprising:
a fabric roll container box adapted for securing a roll of fabric material therein, the container box including an aperture for permitting material unwound from the roll of fabric to exit the container box;
a substrate for supporting the container box;
a cutter for cutting a desired length of material from the roll of material.

8. The fabric panel customization system of claim 7, wherein the container box includes a shell defining a pair of opposed walls, a spindle adapted for supporting a roll of material within the shell, a rotary key adapted for engagement with the spindle, wherein rotation of the rotary key causes rotation of the spindle, the rotary key penetrating at least one of the opposed walls, and a front panel positioned between the pair of opposed walls adapted to permit material unwound from the roll to exit the shell.

9. The fabric panel customization system of claim 7, wherein the front panel of the container box defines a slot through which material unwound from the roll is guided.

10. The fabric panel customization system of claim 7, wherein at least one of the pair of opposed walls of the container box further comprises a window.

11. The fabric panel customization system of claim 7, wherein the front panel of the container box is in a hinged relationship with the shell such that an interior of the shell is accessible by opening the front panel.

12. The fabric panel customization system of claim 7, wherein the container box further comprises a base panel having a securement member for securement with a substrate.

13. The fabric panel customization system of claim 7, wherein the container box further comprises a guide member integral with the pair of opposed walls.

14. A method for customizing fabric panels for a window covering, the method comprising:
determining a desired length of a fabric panel for the window covering;
unwinding fabric panel material from a roll secured within a container box that includes a rotary key adapted for operative engagement with the roll, wherein unwinding panel material includes rotating the rotary key in a first direction;
causing panel material to exit the container box;
measuring a desired length of panel material to match the determined length of the fabric panel; and
cutting the measured panel material.

15. The method of claim 14, further comprising winding fabric panel material into the container box and onto the roll by rotating rotary key in a second direction opposite the first direction.

16. The method of claim 14, further comprising monitoring the fabric material on the roll through a window of the container box.

17. The method of claim 14, wherein cutting the measured panel material includes heating a blade of a cutter.
